(19) United States
(12) Patent Application Publication
(10) Pub. No.: US 2025/0336125 A1
(43) Pub. Date: Oct. 30, 2025

(54) METHOD, DEVICE, STORAGE MEDIUM AND PROGRAM PRODUCT FOR IMAGE GENERATION

(71) Applicant: Beijing Zitiao Network Technology Co., Ltd., Beijing (CN)

(72) Inventor: Bingchuan Li, Beijing (CN)

(21) Appl. No.: 18/861,560

(22) PCT Filed: Mar. 31, 2023
(86) PCT No.: PCT/CN2023/085631

§ 371 Date: Jul. 10, 2025

(30) Foreign Application Priority Data
Apr. 29, 2022 (CN) 202210472391.1

(51) Int. Cl. G06T 11/60; G06T 5/50; G06T 5/60

(52) U.S. Cl. CPC G06T 11/60; G06T 5/50; G06T 5/60; G06T 2207/20084; G06T 2207/20224

(57) ABSTRACT

The embodiments of the present disclosure of the present disclosure provides a method, device, electronic device, computer storage medium, computer program product and computer program of image generation. The method comprises: obtaining original image; processing the original image to generate a first image and a second image, wherein the first image is an image generated by encoding the original image, and the second image is an image generated by encoding and editing the original image; obtaining loss information based on the first image and the original image; and generating a target transform image by correcting the second image based on the loss information.

### CROSS REFERENCE

This application claims priority for Chinese Patent Application No. 202210472391.1 submitted to the Chinese Patent Office on Apr. 29, 2022, entitled “METHOD, DEVICE, STORAGE MEDIUM, AND PROGRAM PRODUCT FOR IMAGE GENERATION”, which is incorporated herein by reference in its entirety.

### FIELD

The embodiments of the present disclosure of the present disclosure relates to the field of computer and network communication, inparticular to a method, apparatus, electronic device, computer storage medium, computer program product and computer program for image generation.

### BACKGROUND

With the development of technology, more and more applications, such as short video applications (APPs), are integrating into users' lives and gradually enriching their leisure time. Users may record their lives through videos, photos, and upload them to the short video APP. Some applications may be used to edit images and change their attributes, such as editing different expressions, poses, colors, etc.

The conventional image editing solutions use some neural network models to encode the image first, modify the attributes of the encoding, and then reconstruct them into an image. However, there is a trade-off between an editing process and a reconstruction process. If the quality of attribute editing is ensured, the effect of the reconstruction process will deteriorate, resulting in a significant difference between the generated image and the original image, as well as a poor editing effect on the image.

### SUMMARY

The embodiments of the present disclosure of the present disclosure provides a method, an apparatus, electronic device, computer storage medium, computer program product and computer program for image generation.

In a first aspect, the embodiments of the present disclosure of the present disclosure provide method of image generation, including:
obtaining an original image;
processing the original image to generate a first image and a second image, wherein the first image is an image generated by encoding the original image, and the second image is an image generated by encoding and editing the original image;
obtaining loss information based on the first image and the original image;
generating a target transform image by correcting the second image based on the loss information.

In a second aspect, the embodiments of the present disclosure of the present disclosure provide an image generation device, including:
an image obtaining unit configured to obtain an original image;
an image editing unit configured to process the original image to generate a first image and a second image, wherein the first image is an image generated by encoding the original image, and the second image is an image generated by encoding and editing the original image;
a loss obtaining unit configured to obtain loss information based on the first image and the original image; and
a loss correcting unit configured to generate a target transform image by correcting the second image based on the loss information.

In a third aspect, the embodiments of the present disclosure of the present disclosure provide an electronic device, which comprises: at least one processor and memory;
the memory storing computer executable instructions,
the at least one processor executing the computer executable instructions stored in the memory, causing the at least one processor implement the method of image generation described in the first aspect and various possible designs of the first aspect.

In a fourth aspect, the embodiments of the present disclosure of the present disclosure provide a computer-readable storage medium in which a computer executable instructions are stored, the computer executable instructions, when executed by a processor, implementing the method described in the first aspect and various possible designs in the first aspect above.

In a fifth aspect, the embodiments of the present disclosure of the present disclosure provides a computer program product, comprising computer executable instructions thereon, which when executed by a processor, implement the method of image generation described in the first aspect and various possible designs in the first aspect.

In a sixth aspect, the embodiments of the present disclosure of the present disclosure provides a computer program that, when executed by a processor, implementing the method of image generation described in the first aspect and various possible designs in the first aspect.

The method, apparatus, electronic device, computer storage medium, computer program product and computer program for image generation provided by the embodiments of the present disclosure of the disclosure obtain an original image; process the original image to generate a first image and a second image, wherein the first image is an image generated by encoding the original image, and the second image is an image generated by encoding and editing the original image; obtain loss information based on the first image and the original image; and generate a target transform image by correcting the second image based on the loss information.

### BRIEF DESCRIPTION OF THE DRAWINGS

In order to more clearly describe the technical solutions in the embodiments of the present disclosure of the present disclosure or related technologies, the following will briefly introduce the drawings needed in the embodiments or related technical descriptions. It is obvious that the drawings in the following description are some embodiments of the present disclosure. For ordinary technicians in the art, they may also obtain other drawings according to these drawings without paying creative labor.

FIG. 1 is an example diagram of the model architecture of the method of image generation provided by one embodiments of the present disclosure.

FIG. 2 is a flowchart of the method of image generation provided by one embodiments of the present disclosure.

FIG. 3 is a flowchart of the method of image generation provided by another embodiments of the present disclosure.

FIG. 4 is a flowchart of the method of image generation provided by another embodiments of the present disclosure.

FIG. 5 is a flowchart of the method of image generation provided by another embodiments of the present disclosure.

FIG. 6 is a flowchart of the method of image generation provided by another embodiments of the present disclosure.

FIG. 7 is a flowchart of the method of image generation provided by another embodiments of the present disclosure.

FIG. 8 is a flowchart of the method of image generation provided by another embodiments of the present disclosure.

FIG. 9 is an example diagram of the obtaining reference image and the corresponding preliminary transform image provided in one embodiments of the present disclosure.

FIG. 10 is an example diagram of obtaining a second reconstructed image and a third reconstructed image provided by a embodiments of the present disclosure.

FIG. 11 is a flowchart of the method of image generation provided by another embodiments of the present disclosure.

FIG. 12 is a schematic diagram of training a second preset model and a third encoder provided by an embodiment of the present disclosure.

FIG. 13 is a structural block diagram of an image generation device provided by an embodiment of the present disclosure.

FIG. 14 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Based on the embodiments in the present disclosure, all other embodiments obtained by those skilled in the art without creative efforts fall within the protection scope of the present disclosure.

The terms “first”, “second” and the like in the embodiments of the present disclosure are merely used for description purposes, and cannot be understood as indicating or implying relative importance or implicitly indicating the number of the indicated technical features.

To resolve the foregoing technical problem, an embodiment of the present disclosure provides an method of image generation, applicable to an application scenario: for example, editing an expression and an orientation of a face and a pet, first obtaining an original image, and processing the original image to generate a first image and a second image, where the first image is an image generated by encoding the original image, and the second image is an image generated by encoding and editing the original image; obtaining loss information based on the first image and the original image; and correcting the second image based on the loss information to generate a target transformed image, that is, an image of the face and the pet after the expression and the orientation are edited. The first image and the second image are acquired for the original image, the loss information existing in the second image is measured through the first image and the original image, then the second image is corrected based on the loss information to obtain the target transformation image, the influence of the loss information is reduced as much as possible, a more realistic transformation image is obtained, and the image quality is improved.

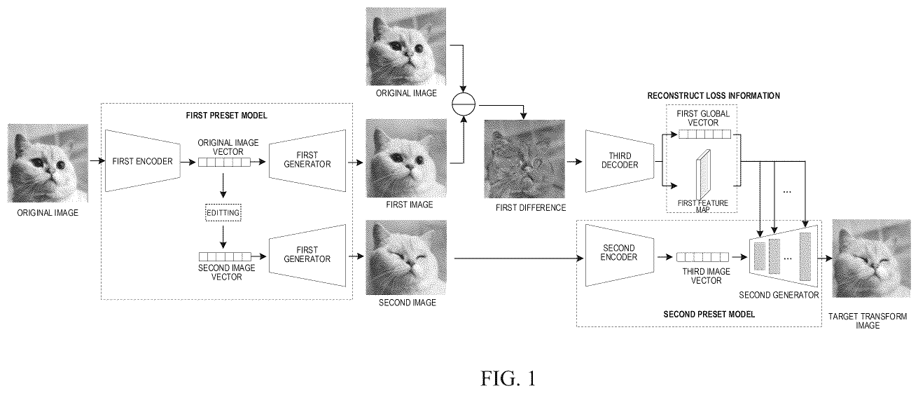

The method of image generation provided by the embodiment of the present disclosure is applicable to the model architecture shown in FIG. 1, and processes an original image by using a first preset model to generate a first image and a second image, where the first image is an image directly reconstructed after encoding the original image, and the second image is an image reconstructed after changing an image attribute after encoding the original image; obtains loss information according to the first image and the original image; and corrects the second image according to the loss information by using a second preset model to generate a target transformed image.

The method of image generation provided by the embodiments of the present disclosure will be described in detail below with reference to specific embodiments.

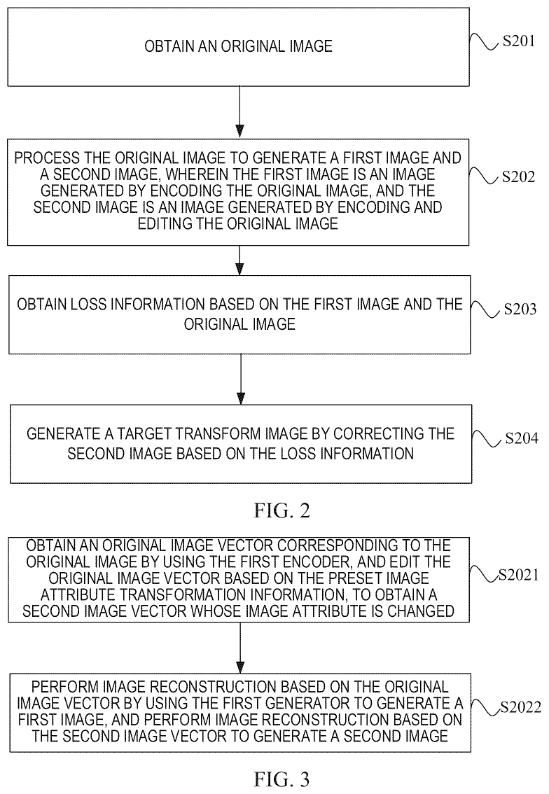

Referring to FIG. 2, FIG. 2 is a schematic flowchart of an method of image generation provided by an embodiment of the present disclosure. The method in this embodiment may be applied to a terminal device or a server, and the method of image generation includes the following.
S201, obtain an original image.

In this embodiment, the original image is a to-be-processed image, for example, in some application scenarios, the original image is a face image, a pet image, or the like that needs to be edited.
S202, process the original image to generate a first image and a second image, wherein the first image is an image generated by encoding the original image, and the second image is an image generated by encoding and editing the original image.

In this embodiment, the original image may be encoded, and the image is directly reconstructed based on the original image to obtain the first image, which is used to reflect the reconstruction loss in comparison with the original image. In addition, the original image is encoded and edited, and image attributes are changed on the basis of the original image encoding, including but not limited to changing to different expressions, postures, colors, etc., and then the image is reconstructed based on the edited image to obtain the second image. That is, the second image changes image attributes such as expressions, postures, colors, etc., of the original image, but there is a reconstruction loss, such as a background change or some other details change.

Optionally, a first preset model may be pre-trained, and the model is used to process the original image and output the first image and the second image.
S203, obtain loss information based on the first image and the original image.

In this embodiment, although the objective of this embodiment is to generate the transformed image after the image attribute is changed based on the original image, since there is a certain error in the process of encoding and reconstructing the original image, that is, the above reconstruction loss, the reconstruction loss also exists in the second image, and cannot be directly used as a final result. In this embodiment, the first image is compared with the original image to reflect the reconstruction loss, to obtain the loss information. Since the first image is an image obtained only through the encoding and reconstruction process, and the middle is not edited, the difference between the first image and the original image is the reconstruction loss in the encoding and reconstruction process, and the loss information can be obtained based on the first image and the original image, so as to correct the second image based on the loss information, to reduce the influence of the reconstruction loss as much as possible, to obtain a more realistic transformed image.
S204, generate a target transform image by correcting the second image based on the loss information.

In this embodiment, since the second image is also subjected to the original image encoding and reconstruction process, there is also a reconstruction loss, and the second image is corrected based on the loss information, so that the influence of the reconstruction loss in the second image can be reduced as much as possible, and a more realistic transformed image can be obtained.

Optionally, a second preset model may be pre-trained, and the model is used to correct the second image by using the loss information, thereby reducing an impact of reconstruction loss, and finally, the corrected image is used as the target transformed image. Optionally, the second image and the loss information may be input from the foremost end of the second preset model as an entry of the second preset model; or the second image is input from the foremost end of the second preset model as an entry of the second preset model, and the loss information is input to an intermediate layer of the second preset model. The output of the second preset model is the target transformed image after the correction.

According to the method of image generation provided in this embodiment, an original image is obtained; the original image is processed to generate a first image and a second image, where the first image is an image generated by encoding the original image, and the second image is an image generated by encoding and editing the original image; loss information is obtained based on the first image and the original image; and the second image is corrected based on the loss information to generate a target transformed image. The first image and the second image are acquired for the original image, the loss information existing in the second image is measured through the first image and the original image, then the second image is corrected based on the loss information to obtain the target transformation image. The influence of the loss information is reduced as much as possible, a more realistic transformation image is obtained, and the image quality is improved.

Based on the foregoing embodiment, the processing the original image to generate the first image and the second image in S202 may include:

The original image is processed by using a first preset model to generate a first image and a second image.

In this embodiment, the original image may be processed more quickly and conveniently by using the pre-trained first preset model to generate the first image and the second image.

Optionally, the first preset model includes a first encoder and a first generator, referring to FIG. 1; further, as shown in FIG. 3, the processing an original image by using a first preset model to generate a first image and a second image may include:
S2021, obtain an original image vector corresponding to the original image by using the first encoder, and edit the original image vector based on the preset image attribute transformation information, to obtain a second image vector whose image attribute is changed.
S2022, perform image reconstruction based on the original image vector by using the first generator to generate a first image, and perform image reconstruction based on the second image vector to generate a second image.

In this embodiment, the first encoder in the first preset model is configured to encode the original image to obtain an original image vector (which belongs to W distribution, differs from input Gaussian distribution N, and changes in W distribution can control specific generated image attributes), and further, edit the original image vector based on preset image attribute transformation information, and change one or more image attributes in the original image vector to obtain a second image vector; and the first generator is configured to perform image reconstruction based on the image vector, specifically, reconstruct the original image vector into a contrast image, and reconstruct the second image vector into a second image.

Optionally, the first generator in this embodiment may borrow a generator in a StyleGAN model (a style-based generative adversarial network), where the StyleGAN model can generate a high-quality image through noise control random change, the StyleGAN model includes a Mapping Net network and a generator, the Mapping Net network is used to encode random noise, and the generator is used to reconstruct the encoding into an image.

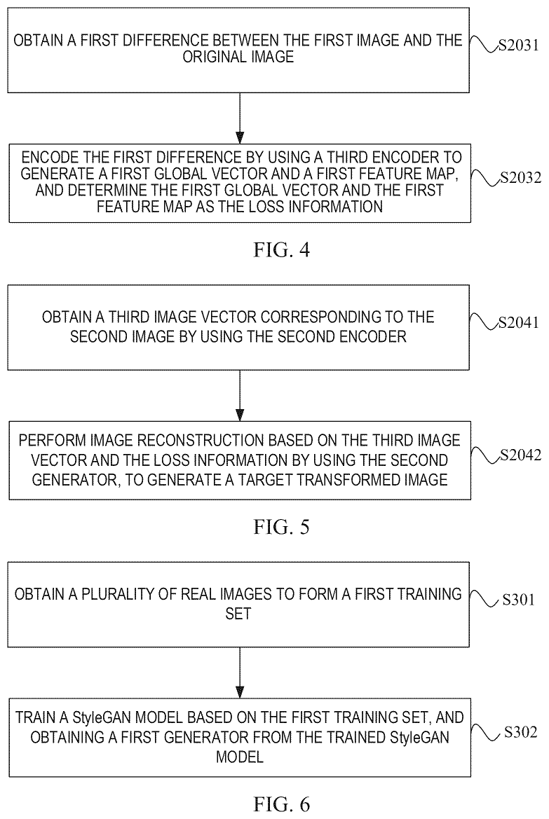

Based on any one of the foregoing embodiments, as shown in FIG. 4, the obtaining loss information based on the first image and the original image at S203 may specifically include:
S2031, obtain a first difference between the first image and the original image; and
S2032, encode the first difference by using a third encoder to generate a first global vector and a first feature map, and determine the first global vector and the first feature map as the loss information.

In this embodiment, because the first image is an image obtained only after the first encoder and the first generator, and no attribute change occurs in the process, a difference between the first image and the original image is reconstruction loss generated in a decoding and reconstruction process of the first preset model. Therefore, referring to FIG. 1, a difference between the first image and the original image is obtained to obtain a first difference, and then the first difference is encoded by using a pre-trained third encoder to generate a first global vector (belonging to W distribution) and a first feature map, and the first global vector and the first feature map are used as loss information to represent reconstruction loss. Optionally, a structure of the third encoder is similar to a structure of the first encoder, and the image with the first difference value can be converted into a form of a vector (belonging to W distribution) by extracting a feature map, where both the extracted last feature map and the vector obtained through conversion serve as output of the third encoder.

Based on any one of the foregoing embodiments, the correcting the second image based on the loss information to generate a target transformed image at S204 specifically includes:
correcting the second image based on the loss information by using a second preset model to generate a target transformed image.

In this embodiment, the second image is corrected based on the loss information by using the pre-trained second preset model, which is more convenient and faster, more accurate, and better in correction effect, and optionally, the second image and the loss information may be input from the front end of the second preset model as an entry of the second preset model; or the second image is input from the front end of the second preset model as an entry of the second preset model, and the loss information is input to an intermediate layer of the second preset model. The output of the second preset model is the target transformed image after modification.

Optionally, the second preset model includes a second encoder and a second generator, referring to FIG. 1. Further, as shown in FIG. 5, the correcting the second image based on the loss information by using a second preset model to generate a target transformed image includes:
S2041, obtain a third image vector corresponding to the second image by using the second encoder.
S2042, perform image reconstruction based on the third image vector and the loss information by using the second generator, to generate a target transformed image.

In this embodiment, the second encoder in the second preset model is configured to encode the second image to obtain a third image vector (belonging to W distribution), and further, the second generator in the second preset model performs image reconstruction based on the third image vector and the loss information obtained in the foregoing process, to generate the target transformed image. A structure of the second encoder is similar to a structure of the first encoder, a structure of the second generator is similar to a structure of the first generator, and the second generator has more loss information processing. Optionally, the third image vector and the loss information may be input from the foremost end of the second generator as an entry of the second generator; or the second image is input from the foremost end of the second generator as an entry of the second generator, and the loss information is input to an intermediate layer of the second generator for processing.

In an optional embodiment, when the second generator is used to perform image reconstruction based on the third image vector and the loss information to generate the target transformed image, the third image vector is used as input data and input to the second generator for processing; the first global vector and the first feature map are injected into an intermediate layer of the second generator, and the intermediate layer fuses the feature map output by processing the third image vector; and the fusion result continues to be processed through an output layer of the second generator to generate the target transformed image.

In this embodiment, when the first global vector and the first feature map are injected into the intermediate layer of the second generator and fused with the feature map output by the intermediate layer through processing the third image vector, the first feature map may be multiplied by the feature map extracted by each intermediate layer, and then the value of each channel in the multiplication result is multiplied by the value of the channel corresponding to the first global vector to implement fusion; and finally, the target transformed image output through the output layer of the second generator is the transformed image corrected for reconstruction loss, which is closer to the initial image, and has a better transformation effect.

Various models involved in the foregoing embodiments need to be trained in advance, and this implementation further provides training methods in various embodiments, which are specifically as follows.

In an optional embodiment, the first generator is a generator in a StyleGAN model, and the StyleGAN model includes a Mapping Net network and the first generator. Therefore, a training process of the first generator is shown in FIG. 6, including:
S301, obtain a plurality of real images to form a first training set; and
S302, train a StyleGAN model based on the first training set, and obtaining a first generator from the trained StyleGAN model.

In this embodiment, random noise may be obtained, the random noise is mapped to a random image vector by using the Mapping Net network, then a first generator is used to perform image reconstruction based on the random image vector to generate a reconstructed image, a Mapping Net network and the first generator are optimized based on loss based on the reconstructed image and real image acquisition loss in the first training set, and after training is completed, the first generator in the StyleGAN model may be extracted as the first generator in this embodiment, so that the first generator inherits excellent performance of the StyleGAN model.

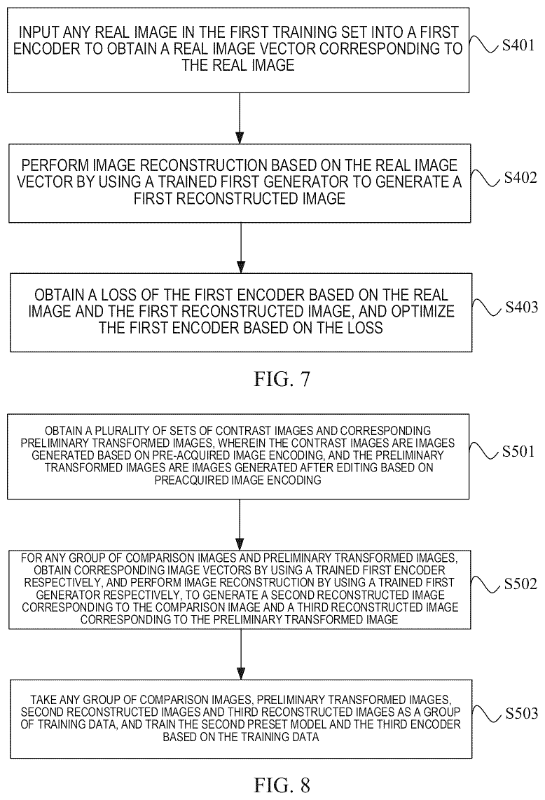

In an optional embodiment, a training process of the first encoder is shown in FIG. 7, including:
S401, input any real image in the first training set into a first encoder to obtain a real image vector corresponding to the real image;
S402, perform image reconstruction based on the real image vector by using a trained first generator to generate a first reconstructed image; and
S403, obtain a loss of the first encoder based on the real image and the first reconstructed image, and optimize the first encoder based on the loss.

In this embodiment, since the purpose of the first encoder is to encode the image into the image vector of W distribution, which is inverse to the process of the first generator, the first encoder and the first generator may be considered to be jointly trained. Since the first generator has completed the training, it may be considered that the loss generated during the joint training is generated by the first encoder, the model parameters of the first generator may be fixed, and the first encoder may be separately optimized. That is, any real image is input into the first encoder to obtain a real image vector corresponding to the real image (satisfying W distribution), and the real image vector is input into the first generator for image reconstruction to generate a first reconstructed image, where a difference between the first reconstructed image and the real image is considered to be generated by the first encoder, the loss of the first encoder may be obtained based on the real image and the first reconstructed image, and the first encoder is optimized based on the loss, so that the reconstructed image after being encoded by the first encoder may be closer to the image before encoding.

In an optional embodiment, the second preset model includes a second encoder and a second generator, and the second encoder, the second generator, and the third encoder of the second preset model may be jointly trained. The training process is shown in FIG. 8, including:
S501, obtain a plurality of sets of contrast images and corresponding preliminary transformed images, wherein the contrast images are images generated based on pre-acquired image encoding, and the preliminary transformed images are images generated after editing based on pre-acquired image encoding;
S502, for any group of comparison images and preliminary transformed images, obtain corresponding image vectors by using a trained first encoder respectively, and perform image reconstruction by using a trained first generator respectively, to generate a second reconstructed image corresponding to the comparison image and a third reconstructed image corresponding to the preliminary transformed image; and
S503, take any group of comparison images, preliminary transformed images, second reconstructed images and third reconstructed images as a group of training data, and train the second preset model and the third encoder based on the training data.

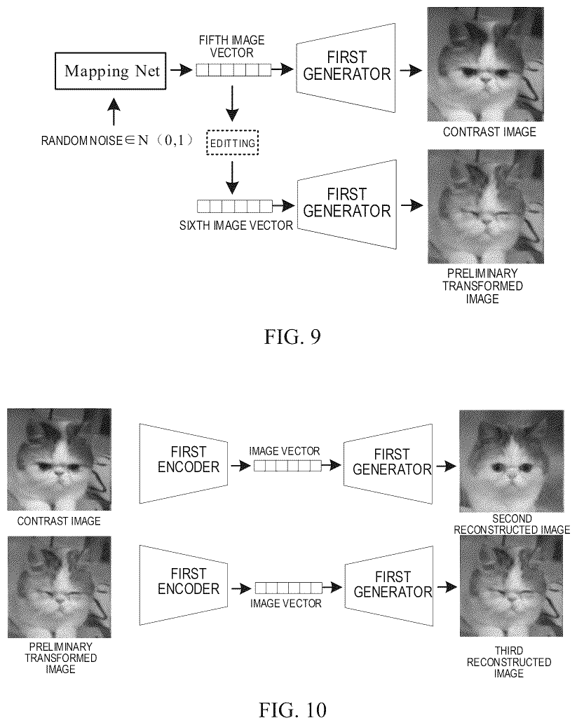

In this embodiment, a plurality of groups of reference images and corresponding preliminary transformed images may be first acquired, where the reference images are images directly reconstructed after pre-acquired image encoding, and the preliminary transformed images are images reconstructed after image attributes are changed for the pre-acquired image encoding, similar to the first image and the second image in the foregoing embodiment. The comparison image and the corresponding preliminary transformed image may be obtained by processing the real image by using the first model in the same manner as the first image and the second image, that is, the pre-obtained image encoding is obtained by encoding the real image by using the first model; or may be implemented by using the process shown in FIG. 9, and specifically includes:
obtaining a plurality of random noises, and for any random noise, mapping the random noise into a fifth image vector through a trained Mapping Net network, and editing the fifth image vector based on preset image attribute transformation information to obtain a sixth image vector; and performing image reconstruction based on the fifth image vector by using a trained first generator to generate a contrast image, and performing image reconstruction based on the sixth image vector to generate a preliminary transformed image.

In this embodiment, the pre-acquired image encoding is to map any random noise to a fifth image vector through a Mapping Net network, and does not need to encode a real image.

Further, as shown in FIG. 10, for any group of comparison images and preliminary transformed images, a trained first encoder is used to obtain corresponding image vectors, and a trained first generator is used to perform image reconstruction, to generate a second reconstructed image corresponding to the comparison image and a third reconstructed image corresponding to the preliminary transformed image. That is, there are four images in total:
a contrast image and a corresponding second reconstructed image; and
a preliminary transformed image and a corresponding third reconstructed image.

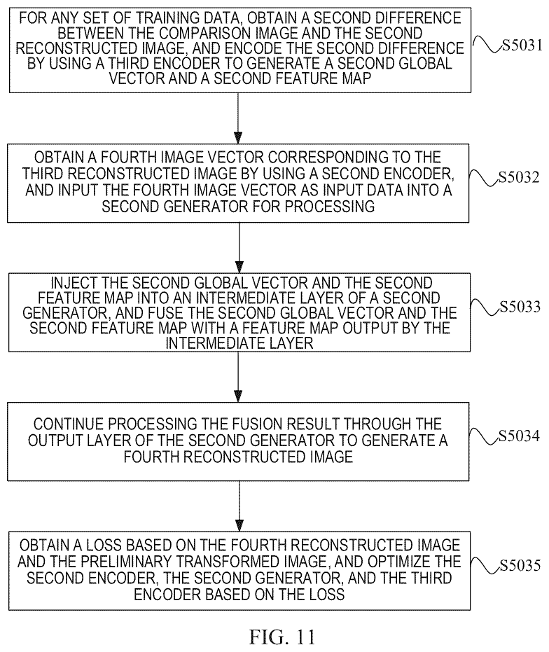

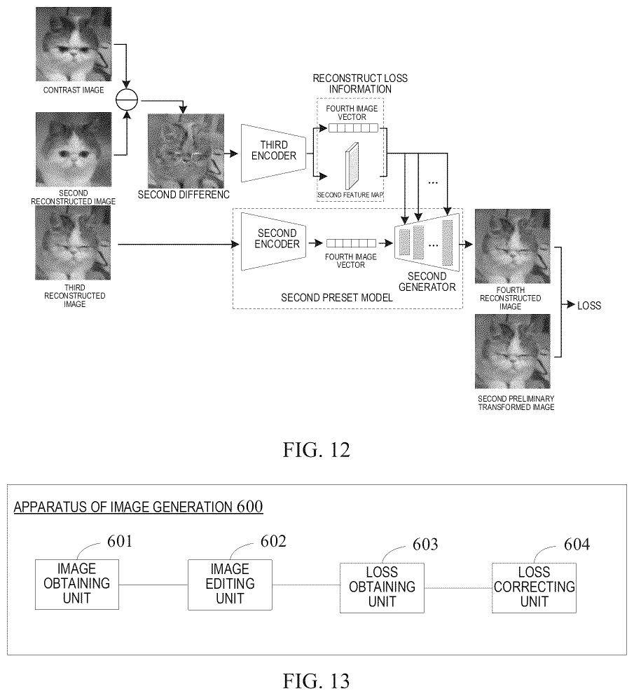

The four images are used as a group of training data, and the second encoder, the second generator, and the third encoder of the second preset model are jointly trained to better improve the model effect. The specific training steps are shown in FIGS. 11 and 12, including:
S5031, for any set of training data, obtain a second difference between the comparison image and the second reconstructed image, and encode the second difference by using a third encoder to generate a second global vector and a second feature map;
S5032, obtain a fourth image vector corresponding to the third reconstructed image by using a second encoder, and input the fourth image vector as input data into a second generator for processing;
S5033, inject the second global vector and the second feature map into an intermediate layer of a second generator, and fuse the second global vector and the second feature map with a feature map output by the intermediate layer;
S5034, continue processing the fusion result through the output layer of the second generator to generate a fourth reconstructed image; and
S5035, obtain a loss based on the fourth reconstructed image and the preliminary transformed image, and optimize the second encoder, the second generator, and the third encoder based on the loss.

In this embodiment, the comparison image and the second reconstructed image are used to obtain the second difference, and the third encoder is used to encode the second difference to generate the second global vector (belonging to W distribution) and the second feature map as the loss information. In addition, the second encoder is used to encode the third reconstructed image to obtain the corresponding fourth image vector (belonging to W distribution), and it should be noted that the execution sequence of the third reconstructed image encoding process in S5031 and S5032 may not be limited, or may be executed simultaneously.

Further, the fourth image vector is used as input data, the fourth image vector is input from the second generator to the front end, the second global vector and the second feature map are injected into the intermediate layer of the second generator, the second global vector and the second feature map are fused with the feature map output by the intermediate layer through processing of the fourth image vector, the second feature map may be multiplied by the feature map extracted by each intermediate layer during fusion, then the value of each channel of the multiplication result is multiplied by the value of the channel corresponding to the second global vector, and finally the fourth reconstructed image is output through the second generator output layer.

The fourth reconstructed image is a model prediction image, and the preliminary transformed image may be considered as a real image, so that the loss is obtained based on the fourth reconstructed image and the preliminary transformed image, and the second encoder, the second generator, and the third encoder are optimized based on the loss, thereby implementing joint training and better correcting the reconstruction loss.

It should be noted that the model training process in the foregoing embodiment may be performed on a same execution entity as the model application (for example, S201-S204), or may be performed on different execution entities.

FIG. 13 is a structural block diagram of an apparatus of image generation according to an embodiment of the present disclosure. For case of description, only parts related to the embodiments of the present disclosure are shown. Referring to FIG. 13, the apparatus of image generation 600 includes an image obtaining unit 601, an image editing unit 602, a loss obtaining unit 603, and a loss correcting unit 604.

The image obtaining unit 601 is configured to acquire an original image.

The image editing unit 602 is configured to process the original image to generate a first image and a second image, where the first image is an image generated by encoding the original image, and the second image is an image generated by editing the original image.

The loss obtaining unit 603 is configured to obtain loss information based on the first image and the original image.

The loss correcting unit 604 is configured to generate a target transform image by correcting the second image based on the loss information.

In one or more embodiments of the present disclosure, the image editing unit 602 is configured to, when processing the original image to generate the first image and the second image:
process the original image with a first preset model to generate the first image and the second image.

In one or more embodiments of the present disclosure, the first preset model includes a first encoder and a first generator; and
the image editing unit 602 is configured to, when processing the original image by using the first preset model to generate the first image and the second image:
obtain the original image vector corresponding to the original image with the first encoder, and edit the original image vector based on preset image attribute transformation information, to obtain a second image vector whose image attribute is changed; and
perform image reconstruction based on the original image vector by using the first generator to generate a first image, and perform image reconstruction based on the second image vector to generate a second image.

In one or more embodiments of the present disclosure, the loss correcting unit 604 is configured to, when correcting the second image based on the loss information to generate the target transformed image:
correct the second image based on the loss information by using a second preset model to generate a target transformed image.

In one or more embodiments of the present disclosure, the second preset model includes a second encoder and a second generator;
the loss correcting unit 604 is configured to, when correcting the second image based on the loss information by using a second preset model to generate a target transformed image:
obtain a third image vector corresponding to the second image by using the second encoder; and
perform image reconstruction based on the third image vector and the loss information by using the second generator, to generate a target transformed image.

In one or more embodiments of the present disclosure, the loss correcting unit 604 is configured to, when using the second generator to perform image reconstruction based on the third image vector and the loss information to generate the target transformation:
input the third image vector and the loss information to a front end of the second preset model as an input parameter of the second preset model to perform the image reconstruction; or
input the third image vector to the front end of the second preset model as an input parameter of the second preset model, and the loss information to an intermediate layer of the second preset model, to perform the image reconstruction.

In one or more embodiments of the present disclosure, the loss obtaining unit 603 is configured to, when obtaining the loss information based on the first image and the original image:
obtain a first difference between the first image and the original image; and
encode the first difference value with a third encoder to generate a first global vector and a first feature map, and determining the first global vector and the first feature map as the loss information.

In one or more embodiments of the present disclosure, the loss correcting unit 604 is configured to, when using the second generator to perform image reconstruction based on the third image vector and the loss information to generate the target transformed image:
input, to the second generator, the third image vector as input data for processing;
inject, into an intermediate layer of the second generator, the first global vector and the first feature map for fusing with a feature map output from the the intermediate layer by processing the third image vector; and
continue processing a result of the fusing with an output layer of the second generator to generate the target transform image.

The device provided in this embodiment may be configured to perform the technical solutions in the foregoing method embodiments, implementation principles and technical effects of the device are similar, and details are not described herein again in this embodiment.

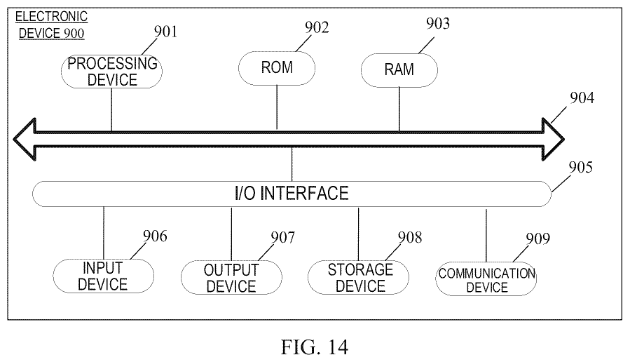

Referring to FIG. 14, which shows a schematic structural diagram of an electronic device 700 suitable for implementing the embodiments of the present disclosure, the electronic device 700 may be a terminal device or a server. The terminal device may include, but is not limited to, a mobile terminal such as a mobile phone, a notebook computer, a digital broadcast receiver, a personal digital assistant (PDA), a portable Android device (PAD), a portable multimedia player (PMP), a vehicle-mounted terminal (for example, a vehicle-mounted navigation terminal), and a fixed terminal such as a digital TV or a desktop computer. The electronic device shown in FIG. 14 is merely an example, and should not bring any limitation to the function and scope of use of the embodiments of the present disclosure.

As shown in FIG. 14, the electronic device 900 may include a processing apparatus (such as a central processing unit, a graphics processor, etc.) 901, which may perform various appropriate actions and processes according to a program stored in a read only memory (ROM) 902 or a program loaded from a storage apparatus 908 into a random access memory (RAM) 903. The RAM 903 further stores various programs and data required for the operation of the electronic device 900. The processing device 901, the ROM 902, and the RAM 903 are connected to each other through a bus 904. An input/output (I/O) interface 905 is also connected to the bus 904.

Generally, the following devices may be connected to the I/O interface 905: an input device 906 including, for example, a touchscreen, a touchpad, a keyboard, a mouse, a camera, a microphone, an accelerometer, a gyroscope, and the like; an output device 907 including, for example, a liquid crystal display (LCD), a speaker, a vibrator, and the like; a storage device 908 including, for example, a magnetic tape, a hard disk, and the like; and a communication device 909. The communication device 909 may allow the electronic device 900 to perform wireless or wired communication with other devices to exchange data. Although FIG. 14 illustrates an electronic device 900 having various devices, it should be understood that not all illustrated devices are required to be implemented or provided. More or fewer devices may alternatively be implemented or provided.

In particular, according to embodiments of the present disclosure, the process described above with reference to the flowchart may be implemented as a computer software program. For example, embodiments of the present disclosure include a computer program product including a computer program carried on a computer-readable medium, where the computer program includes program code for performing the method shown in the flowchart. In such embodiments, the computer program may be downloaded and installed from a network through the communication device 909, or installed from the storage device 908, or installed from the ROM 902. When the computer program is executed by the processing device 901, the foregoing functions defined in the method in the embodiments of the present disclosure are performed. The embodiments of the present disclosure further include a computer program which, when executed by a processor, implements the above functions defined in the method of the embodiments of the present disclosure.

It should be noted that the computer-readable medium described above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program, and the program may be used by or in connection with an instruction execution system, apparatus, or device. In the present disclosure, a computer-readable signal medium may include a data signal propagating in baseband or as part of a carrier wave, wherein computer-readable program code is carried. Such propagated data signals may take many forms including, but not limited to, electromagnetic signals, optical signals, or any suitable combination of the foregoing. A computer readable signal medium may also be any computer readable medium other than a computer readable storage medium that can transmit, propagate, or transport programs for use by or in connection with an instruction execution system, apparatus, or device. The program code contained on the computer-readable medium may be transmitted by using any suitable medium, including but not limited to: a wire, an optical cable, a radio frequency (RF), or the like, or any suitable combination of the foregoing.

The computer readable medium may be included in the electronic device, or may exist alone without being assembled into the electronic device.

The computer readable medium carries one or more programs, and when the one or more programs are executed by the electronic device, the electronic device is enabled to perform the method shown in the foregoing embodiment.

Computer program code for performing the operations of the present disclosure may be written in one or more programming languages, including object-oriented programming languages such as Java, Smalltalk, C++, and conventional procedural programming languages such as the “C” language or similar programming languages. The program code may execute entirely on the user computer, partly on the user computer, as a stand-alone software package, partly on the user computer, partly on a remote computer, or entirely on the remote computer or server. In situations involving a remote computer, the remote computer may be connected to a user computer through any kind of network, including a local area network (LAN) or a wide area network (WAN), or may be connected to an external computer (e.g., through the Internet using an Internet service provider).

The flowchart and block diagrams in the figures illustrate the architecture, functionality, and operation of possible implementations of systems, methods, and computer program products according to various embodiments of the present disclosure. In this regard, each block in a flowchart or block diagram may represent a module, segment, or portion of code containing one or more executable instructions for implementing specified logical functions. It should also be noted that in some alternative implementations, the functions noted in the blocks may also occur in a different order than those noted in the figures. For example, two successively represented blocks may in fact be executed substantially in parallel, or they may sometimes be executed in reverse order, depending on the functionality involved. It is also noted that each block in the block diagrams and/or flowcharts, and combinations of blocks in the block diagrams and/or flowcharts, may be implemented with a dedicated hardware-based system that performs the specified functions or operations, or may be implemented with a combination of dedicated hardware and computer instructions.

The units involved in the embodiments of the present disclosure may be implemented by software or hardware. For example, the first obtaining unit may also be described as “a unit for obtaining at least two Internet Protocol addresses”.

The functions described above herein may be performed, at least in part, by one or more hardware logic components. For example, without limitation, exemplary types of hardware logic components that may be used include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include one or more wire-based electrical connections, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof.

According to a first aspect, one or more embodiments of the present disclosure provide an method of image generation, including:
obtaining an original image;
processing the original image to generate a first image and a second image, wherein the first image is an image generated by encoding the original image, and the second image is an image generated by encoding and editing the original image;
obtaining loss information based on the first image and the original image; and
generating a target transform image by correcting the second image based on the loss information.

According to one or more embodiments of the present disclosure, the processing the original image to generate a first image and a second image includes:
processing the original image with a first preset model to generate the first image and the second image.

According to one or more embodiments of the present disclosure, the first preset model includes a first encoder and a first generator; and
the processing the original image with a first preset model to generate the first image and the second image includes:
obtaining the original image vector corresponding to the original image with the first encoder, and editing the original image vector based on the preset image attribute transformation information to obtain the second image vector after changing the image attribute; and
performing image reconstruction with the first generator based on the original image vector to generate the first image, and performing image reconstruction with the first generator based on the original image vector to generate the second image.

According to one or more embodiments of the present disclosure, the generating a target transform image by correcting the second image based on the loss information includes:
correcting the second image with a second preset model based on the loss information to generate a target transform image.

According to one or more embodiments of the present disclosure, the second preset model includes a second encoder and a second generator; and
the correcting the second image with a second preset model based on the loss information to generate a target transform image includes:
obtaining a third image vector based on the second image with the second encoder; and
performing image reconstruction based on the third image vector and the loss information with the second generator to generate the target transformation image.

According to one or more embodiments of the present disclosure, the performing image reconstruction based on the third image vector and the loss information with the second generator to generate the target transformation image includes:
inputting the third image vector and the loss information to a front end of the second preset model as an input parameter of the second preset model to perform the image reconstruction; or
inputting the third image vector to the front end of the second preset model as an input parameter of the second preset model, and the loss information to an intermediate layer of the second preset model, to perform the image reconstruction.

According to one or more embodiments of the present disclosure, the obtaining loss information based on the first image and the original image includes:
obtaining a first difference between the first image and the original image; and
encoding the first difference value with a third encoder to generate a first global vector and a first feature map, and determining the first global vector and the first feature map as the loss information.

According to one or more embodiments of the present disclosure, the performing image reconstruction based on the third image vector and the loss information with the second generator to generate the target transform image includes:
inputting, to the second generator, the third image vector as input data for processing;
injecting, into an intermediate layer of the second generator, the first global vector and the first feature map for fusing with a feature map output from the the intermediate layer by processing the third image vector; and
continuing processing a result of the fusing with an output layer of the second generator to generate the target transform image.

In a second aspect, according to one or more embodiments of the present disclosure, there is provided an apparatus for image generation, including:
an image obtaining unit configured to obtain an original image;
an image editing unit configured to process the original image to generate a first image and a second image, wherein the first image is an image generated by encoding the original image, and the second image is an image generated by encoding and editing the original image;
a loss obtaining unit configured to obtain loss information based on the first image and the original image; and
a loss correcting unit configured to generate a target transform image by correcting the second image based on the loss information.

In one or more embodiments of the present disclosure, the image editing unit is configured to, when processing the original image to generate the first image and the second image:
process the original image with a first preset model to generate the first image and the second image.

In one or more embodiments of the present disclosure, the first preset model includes a first encoder and a first generator; and
the image editing unit is configured to, when processing the original image by using the first preset model to generate the first image and the second image:
obtain the original image vector corresponding to the original image with the first encoder, and edit the original image vector based on preset image attribute transformation information, to obtain a second image vector whose image attribute is changed; and
perform image reconstruction based on the original image vector by using the first generator to generate a first image, and perform image reconstruction based on the second image vector to generate a second image.

In one or more embodiments of the present disclosure, the loss correcting unit is configured to, when correcting the second image based on the loss information to generate the target transformed image:
correct the second image based on the loss information by using a second preset model to generate a target transformed image.

In one or more embodiments of the present disclosure, the second preset model includes a second encoder and a second generator;
the loss correcting unit is configured to, when correcting the second image based on the loss information by using a second preset model to generate a target transformed image:
obtain a third image vector corresponding to the second image by using the second encoder; and
perform image reconstruction based on the third image vector and the loss information by using the second generator, to generate a target transformed image.

In one or more embodiments of the present disclosure, the loss correcting unit is configured to, when using the second generator to perform image reconstruction based on the third image vector and the loss information to generate the target transformation:
input the third image vector and the loss information to a front end of the second preset model as an input parameter of the second preset model to perform the image reconstruction; or
input the third image vector to the front end of the second preset model as an input parameter of the second preset model, and the loss information to an intermediate layer of the second preset model, to perform the image reconstruction.

In one or more embodiments of the present disclosure, the loss obtaining unit 603 is configured to, when obtaining the loss information based on the first image and the original image:
obtain a first difference between the first image and the original image; and
encode the first difference value with a third encoder to generate a first global vector and a first feature map, and determining the first global vector and the first feature map as the loss information.

In one or more embodiments of the present disclosure, the loss correcting unit is configured to, when using the second generator to perform image reconstruction based on the third image vector and the loss information to generate the target transformed image:
input, to the second generator, the third image vector as input data for processing;
inject, into an intermediate layer of the second generator, the first global vector and the first feature map for fusing with a feature map output from the the intermediate layer by processing the third image vector; and
continue processing a result of the fusing with an output layer of the second generator to generate the target transform image.

According to a third aspect, an electronic device is provided according to one or more embodiments of the present disclosure, including:
at least one processor and a memory;
the memory storing computer executable instructions, and
the at least one processor executing the computer executable instructions stored in the memory, causing the at least one processor to implement the method of image generation according to the first aspect and the possible designs of the first aspect.

According to a fourth aspect, one or more embodiments of the present disclosure provide a computer-readable storage medium, where the computer-readable storage medium stores a computer-executable instruction, and when a processor executes the computer-executable instruction, the method of image generation according to the first aspect and the possible designs of the first aspect is implemented.

According to a fifth aspect, according to one or more embodiments of the present disclosure, a computer program product is provided, including a computer-executable instruction, and when a processor executes the computer-executable instruction, the method of image generation according to the first aspect and various possible designs of the first aspect is implemented.

According to a sixth aspect, according to one or more embodiments of the present disclosure, a computer program is provided, where when the computer program is executed by a processor, the method of image generation according to the first aspect and various possible designs of the first aspect is implemented.

The above description is only a preferred embodiment of the present disclosure and a description of the applied technical principle. Those skilled in the art should understand that the scope of the disclosure involved in the present disclosure is not limited to the technical solution formed by the specific combination of the above technical features, and should also cover other technical solutions formed by any combination of the above technical features or equivalent features thereof without departing from the above disclosed concept. For example, the above features and the technical features having similar functions disclosed in the present disclosure are mutually replaced to form a technical solution.

Further, while operations are depicted in a particular order, this should not be understood as requiring the operations to be performed in the particular order shown or in a sequential order. In certain circumstances, multitasking and parallel processing may be advantageous. Likewise, while several specific implementation details are included in the above discussion, these should not be construed as limitations on the scope of the present disclosure. Certain features described in the context of separate embodiments may also be implemented in combination in a single embodiment. Conversely, various features described in the context of a single embodiment may also be implemented in multiple embodiments, alone or in any suitable sub-combination.

Although the subject matter has been described in language specific to structural features and/or method logical acts, it should be understood that the subject matter defined in the appended claims is not necessarily limited to the specific features or acts described above. Rather, the specific features and acts described above are merely example forms of implementing the claims.

1. A method of image generation comprising:
obtaining an original image;
processing the original image to generate a first image and a second image, wherein the first image is an image generated by encoding the original image, and the second image is an image generated by encoding and editing the original image;
obtaining loss information based on the first image and the original image; and
generating a target transform image by correcting the second image based on the loss information.

2. The method of claim 1, wherein processing the original image to generate a first image and a second image comprises:
processing the original image with a first preset model to generate the first image and the second image.

3. The method of claim 2, wherein the first preset model comprises a first encoder and a first generator, and the processing the original image with a first preset model to generate the first image and the second image comprises:
obtaining the original image vector corresponding to the original image with the first encoder, and editing the original image vector based on the preset image attribute transformation information to obtain the second image vector after changing the image attribute; and
performing image reconstruction with the first generator based on the original image vector to generate the first image, and performing image reconstruction with the first generator based on the original image vector to generate the second image.

4. The method of claim 1, wherein generating a target transform image by correcting the second image based on the loss information comprises:
correcting the second image with a second preset model based on the loss information to generate a target transform image.

5. The method of claim 4, wherein the second preset model comprises a second encoder and a second generator, and the correcting the second image with a second preset model based on the loss information to generate a target transform image comprises:
obtaining a third image vector based on the second image with the second encoder; and
performing image reconstruction based on the third image vector and the loss information with the second generator to generate the target transformation image.

6. The method of claim 5, wherein the performing image reconstruction based on the third image vector and the loss information with the second generator to generate the target transformation image comprises:
inputting the third image vector and the loss information to a front end of the second preset model as an input parameter of the second preset model to perform the image reconstruction; or
inputting the third image vector to the front end of the second preset model as an input parameter of the second preset model, and the loss information to an intermediate layer of the second preset model, to perform the image reconstruction.

7. The method of claim 5, wherein the obtaining loss information based on the first image and the original image comprises:
obtaining a first difference between the first image and the original image; and
encoding the first difference value with a third encoder to generate a first global vector and a first feature map, and determining the first global vector and the first feature map as the loss information.

8. The method of claim 5, wherein the performing image reconstruction based on the third image vector and the loss information with the second generator to generate the target transform image comprises:
inputting, to the second generator, the third image vector as input data for processing;
injecting, into an intermediate layer of the second generator, the first global vector and the first feature map for fusing with a feature map output from the-the intermediate layer by processing the third image vector; and
continuing processing a result of the fusing with an output layer of the second generator to generate the target transform image.

9. (canceled)

10. An electronic device comprising:
at least one processor and a memory;
the memory storing computer executable instructions, and
the at least one processor executing the computer executable instructions stored in the memory, causing the at least one processor to implement acts comprising:
obtaining an original image;
processing the original image to generate a first image and a second image, wherein the first image is an image generated by encoding the original image, and the second image is an image generated by encoding and editing the original image;
obtaining loss information based on the first image and the original image; and
generating a target transform image by correcting the second image based on the loss information.

11. A non-transitory computer-readable storage medium in which computer executable instructions are stored, the computer executable instructions, when executed by a processor, implementing acts comprising:
obtaining an original image;
processing the original image to generate a first image and a second image, wherein the first image is an image generated by encoding the original image, and the second image is an image generated by encoding and editing the original image;
obtaining loss information based on the first image and the original image; and
generating a target transform image by correcting the second image based on the loss information.

12. (canceled)

13. (canceled)

14. The device of claim 10, wherein processing the original image to generate a first image and a second image comprises:
processing the original image with a first preset model to generate the first image and the second image.

15. The device of claim 14, wherein the first preset model comprises a first encoder and a first generator, and the processing the original image with a first preset model to generate the first image and the second image comprises:
obtaining the original image vector corresponding to the original image with the first encoder, and editing the original image vector based on the preset image attribute transformation information to obtain the second image vector after changing the image attribute; and
performing image reconstruction with the first generator based on the original image vector to generate the first image, and performing image reconstruction with the first generator based on the original image vector to generate the second image.

16. The device of claim 10, wherein generating a target transform image by correcting the second image based on the loss information comprises:
correcting the second image with a second preset model based on the loss information to generate a target transform image.

17. The device of claim 16, wherein the second preset model comprises a second encoder and a second generator, and the correcting the second image with a second preset model based on the loss information to generate a target transform image comprises:
obtaining a third image vector based on the second image with the second encoder; and
performing image reconstruction based on the third image vector and the loss information with the second generator to generate the target transformation image.

18. The device of claim 17, wherein the performing image reconstruction based on the third image vector and the loss information with the second generator to generate the target transformation image comprises:
inputting the third image vector and the loss information to a front end of the second preset model as an input parameter of the second preset model to perform the image reconstruction; or
inputting the third image vector to the front end of the second preset model as an input parameter of the second preset model, and the loss information to an intermediate layer of the second preset model, to perform the image reconstruction.

19. The device of claim 17, wherein the obtaining loss information based on the first image and the original image comprises:
obtaining a first difference between the first image and the original image; and
encoding the first difference value with a third encoder to generate a first global vector and a first feature map, and determining the first global vector and the first feature map as the loss information.

20. The device of claim 17, wherein the performing image reconstruction based on the third image vector and the loss information with the second generator to generate the target transform image comprises:
inputting, to the second generator, the third image vector as input data for processing;
injecting, into an intermediate layer of the second generator, the first global vector and the first feature map for fusing with a feature map output from the intermediate layer by processing the third image vector; and
continuing processing a result of the fusing with an output layer of the second generator to generate the target transform image.

21. The non-transitory computer-readable storage medium of claim 11, wherein processing the original image to generate a first image and a second image comprises:
processing the original image with a first preset model to generate the first image and the second image.

22. The non-transitory computer-readable storage medium of claim 21, wherein the first preset model comprises a first encoder and a first generator, and the processing the original image with a first preset model to generate the first image and the second image comprises:
obtaining the original image vector corresponding to the original image with the first encoder, and editing the original image vector based on the preset image attribute transformation information to obtain the second image vector after changing the image attribute; and
performing image reconstruction with the first generator based on the original image vector to generate the first image, and performing image reconstruction with the first generator based on the original image vector to generate the second image.

23. The non-transitory computer-readable storage medium of claim 11, wherein generating a target transform image by correcting the second image based on the loss information comprises:
correcting the second image with a second preset model based on the loss information to generate a target transform image.
